(19) United States
(12) Patent Application Publication
(10) Pub. No.: US 2010/0086855 A1
(43) Pub. Date: Apr. 8, 2010

(54) CATHODE MATERIAL, MANUFACTURING METHOD OF CATHODE MATERIAL, AND NONAQUEOUS ELECTROLYTE SECONDARY BATTERIES PROVIDED WITH THE CATHODE MATERIAL

(75) Inventors: Mariko Kohmoto, Kyoto-shi (JP); Toru Tabuchi, Kyoto-shi (JP); Tokuo Inamasu, Kyoto-shi (JP); Toshio Murata, Kyoto-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: GS YUASA CORPORATION, Kyoto-shi (JP)

(21) Appl. No.: 12/504,165

(22) Filed: Jul. 16, 2009

(30) Foreign Application Priority Data
Oct. 3, 2008 (JP) 2008-258312

(51) Int. Cl. H01M 4/58

(52) U.S. Cl. 429/231.6; 252/182.1

(57) ABSTRACT

An object is to provide a positive electrode material capable of increasing a discharge capacity of a nonaqueous electrolyte secondary battery, a production method thereof, and the like. Provided are a positive electrode material having a particulate active substance containing lithium manganese phosphate, wherein the particulate active substance is provided with a membranous material containing carbon and attached to the surface of the particulate active substance, and a projecting material containing carbon and projecting outward from the surface of the particulate active substance or the membranous material, a method for producing a positive electrode material having a particulate active substance containing lithium manganese phosphate, which performs a hydrothermal synthesis step of forming a particle containing lithium manganese phosphate by a hydrothermal method in the presence of a first organic compound with a molecular weight of 350 or less, which has two or more hydroxy groups in a molecule, and a calcination step of calcinating the particle in the presence of a second organic compound with a molecular weight of 500 or more, which has a hydroxy group in a molecule, and the like.

### FIELD OF THE INVENTION

The present invention relates to a positive electrode material and a production method of a positive electrode material, a positive electrode material produced by the production method, and a nonaqueous electrolyte secondary battery having the positive electrode material.

### DESCRIPTION OF THE RELATED ART

In recent years, a nonaqueous electrolyte secondary battery, typically represented by a lithium ion secondary battery, which has a comparatively high energy density and is excellent in cycle characteristics have drawn attention as a power supply of portable devices such as cell phones and laptop computers, or electrical automobiles, or the like.

For a positive electrode material of a nonaqueous electrolyte secondary battery, for example, a positive electrode material containing a polyanion-type substance, typically represented by lithium iron phosphate (LiFePO₄), has been conventionally known from the viewpoint that the positive electrode material hardly releases oxygen that could be an ignition factor even in a comparatively high temperature condition and thereby safety of a battery can be highly maintained.

Among positive electrode materials containing polyanion substances, it has been known that a positive electrode material containing lithium iron phosphate (LiFePO₄) can give a sufficient discharge capacity that is, for example, 155 mAh/g with respect to a theoretical capacity of 170 mAh/g, at the discharge condition of 0.1 ItmA in a nonaqueous electrolyte secondary battery.

Furthermore, for a positive electrode material containing lithium iron phosphate (LiFePO₄), for example, a positive electrode material obtained by loading carbon generated by thermal decomposition of a lower alcohol, a polyvinyl alcohol, or the like, on particles containing lithium iron phosphate (LiFePO₄) in order to improve high rate discharge characteristics is disclosed (Patent Document 1).

However, as in the Patent Document 1, even with a positive electrode material obtained by loading carbon on lithium iron phosphate (LiFePO₄)-containing particles, a discharge capacity does not necessarily largely increases more than 155 mAh/g in a nonaqueous electrolyte secondary battery at the discharge condition of 0.1 ItmA. In addition, with this type of a positive electrode material, an operating voltage in a nonaqueous electrolyte secondary battery is comparatively as low as about 3.4 V (vs. Li/Li⁺) due to using lithium iron phosphate (LiFePO₄), and thus, an energy density of the nonaqueous electrolyte secondary battery can become comparatively low.

On the other hand, it has been known that, in a positive electrode material containing lithium manganese phosphate (LiMnPO₄) among polyanion-type substances, an operating voltage of a nonaqueous electrolyte secondary battery is increased close to 4 V, and an energy density of the nonaqueous electrolyte secondary battery can be higher than that of a nonaqueous electrolyte secondary battery using lithium iron phosphate (LiFePO₄).

However, a positive electrode material containing lithium manganese phosphate (LiMnPO₄) has a problem such that a discharge capacity is remained at about 30 to 40 mAh/g with respect to a theoretical capacity of 170 mAh/g at the discharge condition of 0.1 ItmA in a nonaqueous electrolyte secondary battery.

Therefore, a positive electrode material containing lithium manganese phosphate (LiMnPO₄) capable of further increasing an operating voltage of a nonaqueous electrolyte secondary battery, which can give a satisfactory discharge voltage to a battery, and a method for producing the positive electrode material have been required.

### PRIOR ART DOCUMENT

### Patent Document

Patent Document 1: Japanese Patent Application Laid-Open (JP-A) No. 2007-109533

### SUMMARY OF THE INVENTION

### Object to be Achieved by the Invention

In view of the above described problems and requests, an object of the present invention is to provide a positive electrode material capable of increasing a discharge capacity of an nonaqueous electrolyte secondary battery and a method for producing the positive electrode material. Further, an object is to provide a nonaqueous electrolyte secondary battery having a comparatively large discharge capacity.

### Means to Achieve the Objects

In order to achieve the above objects, the positive electrode material according to the present invention is characterized by having a particulate active substance containing lithium manganese phosphate, wherein the particulate active substance is provided with a membranous material containing carbon and attached to the surface of the particulate active substance, and a projecting material containing carbon and projecting outward from the surface of the particulate active substance or the membranous material.

It is preferred that the positive electrode material according to the present invention has different peak intensities corresponding to sp² orbital observed in the EELS method in the membranous material and the projecting material.

It is preferred that the positive electrode material according to the present invention has a larger peak intensity corresponding to the sp² orbital observed in the EELS method in the membranous material than a peak intensity of the projecting material.

It is preferred that, in the positive electrode material according to the present invention, the membranous material covers the entire surface of the particulate active substance.

The positive electrode material according to the present invention is characterized by having a particulate active substance containing lithium manganese phosphate, which is obtained by a hydrothermal synthesis step of forming a particle containing lithium manganese phosphate by a hydrothermal method in the presence of a first organic compound with a molecular weight of 350 or less, which has two or more hydroxy groups in a molecule, and a calcination step of calcinating the particle in the presence of a second organic compound with a molecular weight of 500 or more, which has a hydroxy group in a molecule.

It is preferred that, in the positive electrode material according to the present invention, the first organic compound is present so as to contain carbon atoms in a molecule in an amount of 0.15 to 0.60 mol with respect to 1 mol of manganese in the hydrothermal synthesis step. Such a structure gives an advantage of more increasing a discharge capacity of a nonaqueous electrolyte secondary battery.

Furthermore, the method for producing a positive electrode material according to the present invention is a method for producing a positive electrode material having a particulate active substance containing lithium manganese phosphate, which is characterized by performing a hydrothermal synthesis step of forming a particle containing lithium manganese phosphate by a hydrothermal synthesis method in the presence of a first organic compound with a molecular weight of 350 or less, which has two or more hydroxy groups in a molecule, and a calcination step of calcinating the particle in the presence of a second organic compound with a molecular weight of 500 or more, which has a hydroxy group in a molecule.

It is preferred that, in the method for producing a positive electrode material according to the present invention, the first organic compound is present so as to contain carbon atoms in a molecule in an amount of 0.15 to 0.60 mol with respect to 1 mol of manganese in the hydrothermal synthesis step. Such a structure gives an advantage of more increasing a discharge capacity of a nonaqueous electrolyte secondary battery.

The positive electrode material according to the present invention is characterized by being produced by the above described production method.

The nonaqueous electrolyte secondary battery according to the present invention is characterized by having the above described positive electrode material.

The nonaqueous electrolyte secondary battery according to the present invention is characterized by having a positive electrode material produced by the above described production method.

### EFFECT OF THE INVENTION

The positive electrode material according to the present invention exerts an effect capable of increasing a discharge capacity of a nonaqueous electrolyte secondary battery.

### BRIEF DESCRIPTION OF THE DRAWINGS

FIG. 1 shows a diagram expressing a discharge curve of a charge and discharge test in a nonaqueous electrolyte secondary battery;

FIG. 2 shows a diagram expressing a discharge curve of a charge and discharge test in a nonaqueous electrolyte secondary battery;

FIG. 3 shows a diagram expressing a discharge curve of a charge and discharge test in a nonaqueous electrolyte secondary battery;

FIG. 4 shows a diagram expressing a discharge curve of a charge and discharge test in a nonaqueous electrolyte secondary battery;

FIG. 5 shows a photo of a transmission electron microscope of a positive electrode material;

FIG. 6 shows a photo of a transmission electron microscope of a positive electrode material;

FIG. 7 shows an STEM image of a positive electrode material in the embodiment;

FIG. 8 shows an STEM image and an EELS mapping of a positive electrode material in the embodiment;

FIG. 9 shows an STEM image of a positive electrode material in the embodiment;

FIG. 10 shows a graph evaluating a bonding state of carbon by an EELS method; and

FIG. 11 shows a diagram expressing a discharge curve of a charge and discharge test in a nonaqueous electrolyte secondary battery.

### DESCRIPTION OF THE PREFERRED EMBODIMENTS

An embodiment of the positive electrode material according to the present invention will be described in the following.

The positive electrode material of the present embodiment is a positive electrode material having a particulate active substance containing lithium manganese phosphate, and the particulate active substance has a membranous material containing carbon and attached to the surface of the particulate active substance, and a projecting material containing carbon and projecting outward from the surface of the particulate active substance or the membranous material.

The membranous material forms a membranous shape on the surface of the particulate active substance and contains carbon, and mainly obtained by carbonizing a first organic compound with a molecular weight of 350 or less, which has two or more hydroxy groups in a molecule. The membranous material forms a membranous shape with an approximately constant thickness on the surface of the particulate active substance. The thickness of the membranous material is not particularly limited, and it is generally from 1 nm or more to 20 nm or less, and preferably from 3 nm or more to 10 nm or less.

The membranous material is attached so as to cover the surface of the particulate active substance, and it not necessarily limited to a membranous material covering the entire surface of the particulate substance, but may be a membranous material partially covering the surface, and from the viewpoint of enhancing electron conductivity of a positive electrode material, a membranous material preferably covers the entire surface of the particulate active substance.

The projecting material projects outward from the surface of the particulate active substance or the membranous material and contains carbon, and mainly obtained by carbonizing a second organic compound with a molecular weight of 500 or more, which has a hydroxy group in a molecule. The projecting material is loaded on the surface of the particulate active substance or the membranous material, and can also be loaded on a membranous material present in other particles containing lithium manganese phosphate. That is, the projecting material can connect between particles containing lithium manganese phosphate. In addition, the projecting material can take a shape such as a string, a block, a chain, a granule, a scale, or a needle.

In the positive electrode material of the present embodiment, a particulate active substance containing lithium manganese phosphate has the membranous material and the projecting material, and thus, carbons contained in the membranous material and the projecting material enables the positive electrode material to be enhanced in electron conductivity and a discharge capacity of a battery using the positive electrode material can be increased.

Specifically, the positive electrode material of the present embodiment has the projecting material so as to connect between the particulate active substances, and thus, conductive carbon is present at the periphery of the particulate active substances and networks capable of conducting electrons between the particulate active substances can exist in a comparatively large amount. Accordingly, electron conductivity of the positive electrode material is enhanced and a discharge capacity of a battery using the positive electrode material can be increased.

It is preferred that the positive electrode material of the present embodiment has different peak intensities corresponding to sp² orbital observed in the EELS method in the above described membranous material and projecting material. Specifically, it is preferred that the membranous material has a larger peak intensity corresponding to the sp² orbital observed in the EELS method than a peak intensity of the projecting material.

The positive electrode material of the present embodiment is preferably a positive electrode material having a particulate active substance containing lithium manganese phosphate, which is obtained by performing a hydrothermal synthesis step of forming a particle containing lithium manganese phosphate by a hydrothermal method in the presence of a first organic compound with a molecular weight of 350 or less, which has two or more hydroxy groups in a molecule, and a calcination step of calcinating the particle in the presence of a second organic compound with a molecular weight of 500 or more, which has a hydroxy group in a molecule.

Details of the positive electrode material will be described in one embodiment of a production method of a positive electrode material described later.

One embodiment of the method for producing a positive electrode material according to the present invention will be then described.

The method for producing a positive electrode material according to the present embodiment is a method for producing a positive electrode material having a particulate active substance containing lithium manganese phosphate, which performs a hydrothermal synthesis step of forming a particle containing lithium manganese phosphate by a hydrothermal method in the presence of a first organic compound with a molecular weight of 350 or less, which has two or more hydroxy groups in a molecule, and a calcination step of calcinating the particle containing lithium manganese phosphate in the presence of a second organic compound with a molecular weight of 500 or more, which has a hydroxy group in a molecule.

In the method for producing a positive electrode material of the present embodiment, the hydrothermal synthesis step and the calcination step are performed, thereby making it possible to produce a positive electrode material having a particulate active substance on which electron conductive carbon is loaded. That is, in the method for producing a positive electrode material of the present embodiment, a positive electrode material having a particulate active substance obtained by loading carbonized carbon derived from the first organic compound and the second organic compound on a particle containing lithium manganese phosphate (LiMnPO₄) can be produced.

Specifically, in the method for producing a positive electrode material of the present embodiment, it is considered that, due to performing the hydrothermal synthesis step, a particle containing lithium manganese phosphate is formed, and at the same time, the first organic compound is attached to the surface of the particle. It is considered that the first organic compound is attached to the surface of the particle while having an approximately constant thickness.

Further, in the method for producing a positive electrode material of the present embodiment, the calcination step is carried out on particles on which the first organic compound is attached, to thereby first further load the second organic compound on the first organic compound present on the surface of the particle due to a reciprocal action between a hydroxy group of the first compound attached to the particle and a hydroxy group of the second organic compound with a molecular weight of 500 or more, which has a hydroxy group in a molecule, and subsequently, the first organic compound and the second organic compound are carbonized by calcination.

As a result, it is considered that the first organic compound attached to the surface of the particle becomes a membranous material containing carbon, and the second organic compound loaded on the first organic compound becomes a projecting material containing carbon and projecting outward from the membranous material.

In the hydrothermal synthesis step, a particle containing lithium manganese phosphate is formed by a hydrothermal method in the presence of the first organic compound with a molecular weight of 350 or less, which has two or more hydroxy groups in a molecule.

Since the hydrothermal method is employed in the hydrothermal synthesis step, the first organic compound is hardly carbonized and is considered to be able to attach to the surface of the particle without completely becoming carbon. No carbonization of the first organic compound enables hydrophilicity of the first organic compound to be remained also in the calcination step that is subsequently carried out. In addition, it is considered that the hydrophilicity of the first organic compound is derived from two or more hydroxy groups present in a molecule of the first organic compound.

Conventionally known general methods can be employed for the hydrothermal method. For the hydrothermal method, for example, a method which involves injecting an aqueous solution dissolved with raw materials of lithium manganese phosphate in a container capable of being sealed, thereafter heating the external of the container can be employed. Specifically, for example, a method which involves injecting an aqueous solution dissolved with raw materials of lithium manganese phosphate in a container capable of being sealed, thereafter sealing the container, and heating the external of the container at a temperature exceeding 100° C. to allow the internal pressure to be 0.5 to 1.5 MPa can be employed.

The hydrothermal method is used in the hydrothermal synthesis step, and thus, particles containing lithium manganese phosphate can be simply and easily made smaller. Making the particles smaller gives an advantage such that electron conductivity of a positive electrode material having the particulate active substance is more enhanced.

Specifically, in the hydrothermal synthesis step, the raw materials of lithium manganese phosphate including manganese, lithium and phosphoric acid are mixed to form particles containing lithium manganese phosphate.

Various substances can be used as the raw materials of lithium manganese phosphate. For raw materials containing manganese (Mn), examples such as manganese sulfate, manganese oxalate, and manganese acetate can be used. For raw materials containing lithium (Li), examples such as lithium hydroxide and lithium carbonate can be used. For raw materials containing phosphoric acid (PO₄), examples such as ammonium phosphate, diammonium hydrogen phosphate, ammonium dihydrogen phosphate, and lithium phosphate can be used.

The particle has an olivine-type crystal structure and contains a solid solution of lithium manganese phosphate substantially expressed by the chemical composition of LiMnPO₄.

The lithium manganese phosphate is not necessarily limited to those whose chemical composition is expressed by LiMnPO₄, and a coefficient of each element in the above composition formula can fluctuate. Specifically, the chemical composition of the lithium manganese phosphate can be in the range of Li:P:Mn=0.85 to 1.10:1:0.95 to 1.05.

In particular, it has been known that a coefficient of Li in the chemical composition of the lithium manganese phosphate highly tends to be different from a charged ratio of each element in the hydrothermal synthesis. Transition metals other than Mn, such as Fe, Co and Ni, may be contained in the particle, and the particle may have an olivine-type structure in which a part of PO₄ is SiO₄, etc.

The particle generally has an average particle diameter of 20 nm to 1 μm. The particle preferably has an average particle diameter of 20 nm to 50 nm from the viewpoint that electron conductivity of a positive electrode material can be increased.

The first organic compound is not particularly limited as long as it is a first organic compound with a molecular weight of 350 or less, which has two or more hydroxy groups in a molecule, and examples thereof include monosaccharides, disaccharides, and organic acids with a molecular weight of 350 or less, which has two or more hydroxy groups in a molecule. The molecular weight of the first organic compound is generally 100 or more.

Examples of the monosaccharides include glucose, fructose, galactose, and mannose. Examples of the disaccharides include maltose, sucrose, and cellobiose. Examples of the organic acids include ascorbic acid (including erythorbic acid that is an enantiomer), tartaric acid, mevalonic acid, quinic acid, shikimic acid, gallic acid, and caffeic acid.

In particular, for the first organic compound, sucrose, ascorbic acid, and tartaric acid are preferable from the viewpoint that a discharge capacity of a nonaqueous electrolyte secondary battery can be larger.

The first organic compound is preferably a water soluble organic compound from the viewpoint of being easily dissolved in water as a solvent that can be used in the hydrothermal synthesis step. Specifically, the first organic compound is preferably neutral and dissolved in water at 20° C. in an amount of 1% by mass or more.

An example of the first organic compound includes ascorbic acid having a reducing property, but also when tartaric acid without having a reducing property is employed, a discharge capacity of a nonaqueous electrolyte secondary battery can be larger, and thus, whether the first organic compound has a reducing property or not could not be associated with whether a discharge capacity of a nonaqueous electrolyte secondary battery having a positive electrode material produced by employing the first organic compound becomes larger or not, as limited to Test Examples 1 to 16.

It is preferable that, in the hydrothermal synthesis step, the first organic compound is present so as to contain carbon atoms in a molecule in an amount of 0.15 to 0.60 mol with respect to 1 mol of manganese.

By making the first organic compound present so as to contain carbon atoms in a molecule in an amount of 0.15 mol or more with respect to 1 mol of manganese, the first organic compound is more easily attached to the particle, which leads to such an advantage that a discharge capacity of a nonaqueous electrolyte secondary battery using the produced positive electrode material can be larger. By making the first organic compound present so as to contain carbon atoms in a molecule in an amount of 0.60 mol or less with respect to 1 mol of manganese, a ratio of lithium manganese phosphate (LiMnPO₄) contained in the produced positive electrode material is high, which leads to such an advantage that a discharge capacity of a nonaqueous electrolyte secondary battery using the produced positive electrode material can be larger.

By “the first organic compound containing carbon atoms in a molecule in an amount of 0.15 to 0.60 mol with respect to 1 mol of manganese” is meant, for example, when the first organic compound is ascorbic acid having six carbon atoms in a molecule, ascorbic acid in an amount of 0.025 to 0.10 mol with respect to 1 mol of manganese.

In addition, in the hydrothermal synthesis step, formed particles can be washed with a solvent such as deionized water, acetone, or the like, according to necessity. Drying for vaporizing the solvent under reduced pressure can also be performed. In drying, the temperature can be increased to a temperature exceeding room temperature.

In the calcination step, the particle on which the first organic compound that is not completely carbonized is calcinated in the presence of the second organic compound with a molecular weight of 500 or more, which has a hydroxy group in a molecule. That is, before the calcination step is performed, the first organic compound is not completely carbonized.

Two or more hydroxy groups can be present in a molecule in the first organic compound that is not completely carbonized, and thus, due to reciprocal action between these hydroxy groups and a hydroxyl group in the second organic compound with a molecular weight of 500 or more, which has a hydroxy group in a molecule, it can be considered that the second organic compound is easily loaded on the first organic compound.

Then, calcination is performed in the calcination step to carbonize the first organic compound and the second organic compound, and these organic compounds become electron conductive carbons. As a result, a positive electrode material having a particulate active substance on which carbon is loaded is produced and electron conductivity of the positive electrode material can be enhanced.

By “the first organic compound that is not completely carbonized” is meant the first organic compound that is not subjected to a treatment capable of being thermally decomposed or carbonized, for example, a treatment such as heating in a gas at about 400° C. or more for about 30 minutes or more. In other words, by “the first organic compound that is not completely carbonized” is meant the first organic compound that is not substantially carbonized but can include a thermally decomposed or carbonized portion in a part.

In the calcination step, when the particle is calcinated in the presence of the second organic compound with a molecular weight of 500 or more, which has a hydroxy group in a molecule, the second organic compound can be calcinated after the second organic compound is loaded on the particle. By calcinating the second organic compound after it is loaded on the particle, carbon is efficiently loaded on the particle after calcination, which leads to such an advantage that electron conductivity of a positive electrode material can be more enhanced.

For a method of loading the second organic compound on the particle before calcination in the calcination step, a method which involves mixing the particle formed in the hydrothermal synthesis step and the second organic compound together can be adopted. A specific example of the method includes a method which involves mixing using a mortar, a ball mill, a sand mill, a vibratory ball mill, a planetary ball mill, a jet mill, a counter jet mill, a swirling air flow jet mill, sieve, or the like. When mixing, a wet type method in which water or an organic solvent such as ethanol, etc. coexists can be employed.

The second organic compound is not particularly limited as long as it is a water soluble compound with a molecular weight of 500 or more, which has a hydroxy group in a molecule, and examples that can be used for the second organic compound include polyalkylene glycols such as polyethylene glycol, polypropylene glycol, and polyethylene polypropylene glycol, or hydrophilic vinyl polymers such as polyvinyl alcohol, and polyhydroxyalkyl (meth)acrylate, or polyoxyethylene(alkyl) phenyl ether such as polyoxyethylene(tetramethylbutyl) phenyl ether.

Since the second organic compound has a molecular weight of 500 or more, the shape of the projecting material obtained by mainly carbonizing the second organic compound is likely to have a shape of sequentially connecting carbons such as a string, a block, a chain, a granule, a scale, or a needle. The second organic compound preferably has a molecular weight of 100,000 or less, more preferably a molecular weight of 70,000 or less, and further more preferably 66,000 or less from the viewpoint that water solubility is enhanced and hence handling in production can become more easy.

A molecular weight is found from calculation for a compound known in its molecular formula, and for a compound whose molecular formula is not clear such as a general polymer, a molecular weight thereof is found from the following method.

That is, for a polyvinyl alcohol, a molecular weight is found from an average polymerization degree found in the viscosity method described in JIS K6726, and for other organic compounds, molecular weights thereof are found by GPC.

Details of the GPC measurement conditions are as follows.

Measurement equipment: GPC device “HLC-8120GPC” manufactured by TOSOH CORPORATION

Columns: PwXL-6000, PwXL-3000, PwXL-2000

Eluent: pH 0.68, 0.1M-phosphate buffer

Calculation method: weight average molecular weight in pullulan conversion

The hydrophilic vinyl polymer has a constitutional unit derived from a vinyl monomer having a hydroxy group. Specifically, the hydrophilic vinyl monomer has a constitutional unit derived from a vinyl monomer having at least one ethylenically unsaturated bond and a hydroxy group in a molecule.

Examples of the polyhydroxyalkyl (meth)acrylate among the hydrophilic vinyl polymers include hydroxyethyl (meth)acrylate, and the like. Other than these examples, the hydrophilic vinyl polymers include a copolymer obtained by copolymerizing a vinyl monomer having a hydroxy group, etc.

The polyvinyl alcohol among the hydrophilic vinyl polymers is generally obtained by polymerizing a vinyl acetate monomer, followed by hydrolysis. The polyvinyl alcohol has a constitutional unit derived from a vinyl monomer having at least one ethylenically unsaturated bond and a hydroxy group in a molecule, and is included in the hydrophilic vinyl polymers in the present invention.

For the second organic compound, a polyvinyl alcohol, a polyoxyethylene(tetramethylbutyl) phenyl ether [C₈H₁₇—C₆H₄—O—(C₂H₄O)ₙ—H (n=9, 10)] are preferable, and a polyvinyl alcohol is more preferable from the viewpoint that a discharge capacity of a nonaqueous electrolyte secondary battery can be larger.

The second organic compound is preferably used in the calcination step in an amount of about 4 to 6% by mass in a carbon amount conversion based on particles formed in the hydrothermal synthesis step from the viewpoint that a discharge capacity of a nonaqueous electrolyte secondary battery can be larger.

A conventionally known general method can be employed for a calcination method in the calcination step. For example, a calcination method can be carried out in conditions of a temperature at about 500 to 750° C. and about 0.5 to 2 hours, under a nitrogen gas-replaced atmosphere with less oxygen gas, etc. In addition, cooling after calcination is preferably performed gradually so as not to exceed a cooling rate of −1° C./min, for example.

One embodiment of the nonaqueous electrolyte secondary battery according to the present invention will be then described.

The nonaqueous electrolyte secondary battery of the present embodiment is not particularly limited as long as it has a positive electrode material produced by the above described method. Specifically, the nonaqueous electrolyte secondary battery has the positive electrode containing a positive electrode material produced by the above described method, the negative electrode containing a negative electrode material, and a nonaqueous electrolyte containing an electrolyte salt and a nonaqueous solvent, and further, generally has a separator between the positive electrode and the negative electrode and an exterior packaging body packaging these constituting materials. An aspect of the nonaqueous electrolyte secondary battery is not particularly limited, and examples thereof include a coin battery and a button battery, which have a positive electrode, a negative electrode and a monolayer or multilayer separator, and further include a column-form battery, a square-form battery, and a flat-form battery, which have a positive electrode, a negative electrode, and a roll-form separator.

For a nonaqueous solvent and an electrolyte salt contained in the nonaqueous electrolyte, those generally used in a nonaqueous electrolyte secondary battery can be employed.

Examples of the nonaqueous solvent include single substances, for example, cyclic carbonic acid esters such as propylene carbonate, ethylene carbonate, butylene carbonate, and chloroethylene carbonate; cyclic esters such as γ-butyrolactone, and γ-valerolactone; chain carbonates such as dimethyl carbonate, diethyl carbonate, and ethylmethyl carbonate; chain esters such as methyl formate, methyl acetate, and methyl butylate; tetrahydrofuran or a derivative thereof; ethers such as 1,3-dioxane, 1,4-dioxane, 1,2-dimethoxyethane, 1,4-dibutoxyethane, and methyl diglyme; nitriles such as acetonitrile and benzonitrile; dioxolane or a derivative thereof ethylene sulfide, sulfolane, sultone, or derivatives thereof, or a mixture of two or more of these substances, but examples of the nonaqueous solvent are not limited thereto.

Examples of the electrolyte salt include ionic compounds such as LiClO₄, LiBF₄, LiAsF₆, LiPF₆, LiCF₃SO₃, LiN(SO₂CF₃)₂, LiN(SO₂C₂F₅)₂, LiN(SO₂CF₃)(SO₂C₄F₉), LiSCN, LiBr, LiI, Li₂SO₄, Li₂B₁₀Cl₁₀, NaClO₄, NaI, NaSCN, NaBr, KClO₄ and KSCN, and single substances of these ionic compounds, or mixtures of two or more of these substances are included.

A concentration of the electrolyte salt in the nonaqueous electrolyte is preferably 0.5 to 5.0 mol/l, and more preferably 1.0 to 2.5 mol/l in order to surely obtain a nonaqueous electrolyte battery having excellent battery characteristics.

Examples of the negative electrode material include, in addition to lithium metals, lithium alloys (lithium metal-containing alloys such as lithium-aluminum, lithium-lead, lithium-tin, lithium-aluminum-tin, lithium-gallium, and wood's alloys), alloys capable of occluding and releasing lithium, carbon materials (for example, graphite, hard carbon, low-temperature calcinated carbon, and amorphous carbon), metal oxides, lithium metal oxides (such as Li₄Ti₅O₁₂), and polyphosphoric acid compounds.

A powder constituting the negative electrode material preferably has an average particle size of 100 μm or less. In order to form the powder in a predetermined size, a pulverizer or a microseparator may be employed.

Other than the above described main components, the positive electrode and the negative electrode may contain a conductive agent, a bonding agent, a thickening agent, a filler, and the like as other constitutional components.

These other constitutional components are generally obtained by mixing in a mixing method capable of physically, approximately homogeneously mixing. For the mixing method, a mixing method of mixing in a dry type or a wet type in a powder mixing machine such as a V-type mixer, an S-type mixer, a crusher, a ball mill, a planetary ball mill, etc.

The conductive agent is not particularly limited as long as it is an electron conductive material that does not give an adverse effect on battery performance, and examples thereof include one of conductive materials such as natural graphite (such as scaly graphite, scale flake graphite, and soil-form graphite), artificial graphite, carbon black, acetylene black, Ketjen black, carbon whisker, carbon fiber, metallic (such as copper, nickel, aluminum, silver, and gold) powders, metallic fibers, conductive ceramic materials, or a mixture thereof.

Examples of the bonding agent include one of thermoplastic resins such as polytetrafluoroethylene (PTFE), polyvinylidene fluoride (PVDF), polyethylene, and polypropylene, and polymers having rubbery elasticity such as an ethylene-propylene-dienta-polymer (EPDM), sulfonated EPDM, a styrene butadiene rubber (SBR), and a fluorine rubber, or a mixture of two or more of these substances.

Examples of the thickening agent include one of polysaccharides, etc. such as carboxymethyl cellulose and methylcellulose, or a mixture of two or more of these polysaccharides. A thickening agent having a functional group reacting with lithium such as a polysaccharide is preferably deactivated in its functional group, for example, by methylation.

The filler is not particularly limited as long as it is a material that does not give an adverse effect on battery performance, and examples thereof include olefin polymers such as polypropylene and polyethylene, and amorphous silica, alumina, zeolite, and glass.

The separator is preferably a material singly using a porous film, a nonwoven fabric, or the like showing excellent rate characteristics, or a material using a mixture of the above materials in combination.

Examples of materials of the separator include polyolefin resins, typically represented by polyethylene and polypropylene, or polyester resins typically represented by polyethylene terephthalate and polybutylene terephthalate, or polyvinylidene fluoride, a vinylidene fluoride-hexafluoropropylene copolymer, a vinylidene fluoride-perfluorovinyl ether copolymer, a vinylidene-fluoride-tetrafluoroethylene copolymer, a vinylidene fluoride-trifluoroethylene copolymer, a vinylidene fluoride-fluoroethylene copolymer, a vinylidene fluoride-hexafluoroacetone copolymer, a vinylidene fluoride-ethylene copolymer, a vinylidene fluoride-propylene copolymer, a vinylidene fluoride-trifluoropropylene copolymer, a vinylidene fluoride-tetrafluoroethylene-hexafluoropropylene copolymer, and a vinylidene fluoride-ethylene-tetrafluoroethylene copolymer.

Examples of materials of the exterior packaging body include iron or stainless steel plated with nickel, and aluminum, and a metallic resin complex film, and glass.

The nonaqueous electrolyte secondary battery of the present embodiment can be produced by a conventionally known general method. For example, the nonaqueous electrolyte secondary battery can be produced by immersing the nonaqueous electrolyte before or after laminating a separator for the nonaqueous electrolyte secondary battery, and a positive electrode and a negative electrode, and finally sealing with an exterior packaging material.

The present invention is not limited to the above illustrated production method of a positive electrode material, a positive electrode material produced by the production method, and the above illustrated nonaqueous electrolyte secondary battery.

That is, various embodiments used in a general production method of a positive electrode material can be employed within the range where the effects of the present invention are not damaged. Furthermore, various aspects used in a general nonaqueous electrolyte secondary battery can be employed within the range where the effects of the present invention are not damaged.

### EXAMPLES

The present invention will be then more specifically described by way of examples, but the present invention is not limited thereto.

### Test Example 1

A positive electrode material was produced according to the method shown below.

Lithium hydroxide [LiOH.H₂O] and ammonium hydrogen phosphate [(NH₄)₂HPO₄] were respectively dissolved in ion exchange water, and the both solutions were then mixed with stirring.

Manganese sulfate [MnSO₄.5H₂O] was then dissolved in an aqueous solution dissolved with ascorbic acid. Ascorbic acid in an amount of 0.025 mol was used with respect to 1 mol of manganese in manganese sulfate. That is, ascorbic acid was used in such an amount that carbon atoms in a molecule of the ascorbic acid was 0.15 mol with respect to 1 mol of manganese.

Subsequently, this aqueous solution was added to the mixed solution of lithium hydroxide [LiOH.H₂O] and diammonium hydrogen phosphate [(NH₄)₂HPO₄] to thereby obtain a precursor solution. A ratio of Li:P:Mn in the precursor solution was adjusted to 2:1:1 by a molar ratio. This precursor solution was transferred to a tetrafluoroethylene container, the container was then set in a reaction vessel and the inside of the vessel was sufficiently replaced with a N₂ gas and sealed, and synthesis was carried out by a hydrothermal method at 170° C. for 12 hours to perform the hydrothermal synthesis step.

The generated substance was sufficiently washed with deionic water and acetone, and then subjected to vacuum drying at 100° C. for 1 hour, to thereby obtain particles containing LiMnPO₄.

Thereto were added a polyvinyl alcohol (PVA, made by Wako Pure Chemicals K.K., average polymerization degree of 1500) in an amount of 1.2 g per 1 g of the particles and water heated to 60° C. to mix and knead in a mortar, and the resultant mixture was then subjected to a heat treatment at 700° C. for 1 hour in a N₂ gas atmosphere to thereby perform the calcination step. An amount of the polyvinyl alcohol used was set to such an amount that a carbon amount calculated from a mass increase was 5% by mass based on the particles containing LiMnPO₄.

### Test Example 2

A positive electrode material was obtained in the same manner as in Test Example 1 except for using 0.05 mol (0.3 molar equivalent of carbon atoms) of ascorbic acid with respect to 1 mol of manganese (Mn).

### Test Example 3

A positive electrode material was obtained in the same manner as in Test Example 1 except for using 0.075 mol (0.45 molar equivalent of carbon atoms) of ascorbic acid with respect to 1 mol of manganese (Mn).

### Test Example 4

A positive electrode material was obtained in the same manner as in Test Example 1 except for using 0.1 mol (0.6 molar equivalent of carbon atoms) of ascorbic acid with respect to 1 mol of manganese (Mn).

### Test Example 5

A positive electrode material was obtained in the same manner as in Test Example 1 except for using 0.15 mol (0.9 molar equivalent of carbon atoms) of ascorbic acid with respect to 1 mol of manganese (Mn).

### Test Example 6

A positive electrode material was obtained in the same manner as in Test Example 1 except for using 0.2 mol (1.2 molar equivalents of carbon atoms) of ascorbic acid with respect to 1 mol of manganese (Mn).

### Test Example 7

A positive electrode material was obtained in the same manner as in Test Example 1 except for using 0.1 mol (1.2 molar equivalents of carbon atoms) of sucrose with respect to 1 mol of manganese (Mn).

### Test Example 8

A positive electrode material was obtained in the same manner as in Test Example 1 except for using 0.05 mol (0.6 molar equivalent of carbon atoms) of sucrose with respect to 1 mol of manganese (Mn).

### Test Example 9

A positive electrode material was obtained in the same manner as in Test Example 1 except for using 0.1 mol (0.4 molar equivalent of carbon atoms) of tartaric acid with respect to 1 mol of manganese (Mn).

### Test Example 10

A positive electrode material was obtained in the same manner as in Test Example 1 except for using 0.1 mol (0.6 molar equivalent of carbon atoms) of ascorbic acid with respect to 1 mol of manganese (Mn), and using 0.86 g of polyoxyethylene-[4-(1,1,3,3-tetramethylbutyl)phenyl]ether (made by Roche, Ltd., product name “Triton X-100”, average molecular weight of 635) per 1 g of particles in place of polyvinyl alcohol (PVA). Additionally, water was not used. An amount of “Triton X-100” was set to such an amount that a carbon amount calculated from a mass increase was 5% by mass based on the particles containing LiMnPO₄.

### Test Example 11

A positive electrode material was obtained in the same manner as in Test Example 1 except that ascorbic acid was not used.

### Test Example 12

A positive electrode material was obtained in the same manner as in Test Example 1 except for using 0.1 mol (0.6 molar equivalent of carbon atoms) of ascorbic acid with respect to 1 mol of manganese (Mn) and then thermally treating at 700° C. for 1 hour without using a polyvinyl alcohol.

### Test Example 13

A positive electrode material was obtained in the same manner as in Test Example 1 except for performing a hydrothermal synthesis step using 0.1 mol (0.6 molar equivalent of carbon atoms) of ascorbic acid with respect to 1 mol of manganese (Mn), then thermally treating (calcination) at 700° C. for 1 hour, and then performing a calcination step.

### Test Example 14

A positive electrode material was obtained in the same manner as in Test Example 1 except for using 0.1 mol (0.6 molar equivalent of carbon atoms) of citric acid in place of ascorbic acid with respect to 1 mol of manganese (Mn).

### Test Example 15

A positive electrode material was obtained in the same manner as in Test Example 1 except for using 0.1 mol (0.6 molar equivalent of carbon atoms) of maleic acid in place of ascorbic acid with respect to 1 mol of manganese (Mn).

### Test Example 16

Particles containing LiMnPO₄ was obtained in the same manner as in Test Example 1 except that ascorbic acid was not used. These particles were placed in a calcination oven and the temperature of the calcination oven was increased to 600° C., and then, a mixed gas of vaporized methanol and nitrogen (containing 1 vol % of methanol) was fed to the oven so that a carbon mass generated due to thermal decomposition of methanol was 5% by mass to thereby obtain a positive electrode material.

The composition of the elements was measured on the particles containing lithium manganese phosphate obtained by performing the hydrothermal synthesis step by an ICP emission spectral analysis by a molar ratio of Li:P:Mn, and results thereof were shown in Table 1. As recognized from Table 1, the particles containing lithium manganese phosphate obtained by performing a hydrothermal synthesis step has a different composition ratio of contained Li, P and Mn from the composition ratio when charged. Additionally, a composition ratio of Li, P and Mn of the obtained particles can fluctuate.

TABLE 1

| | Molar ratio | Molar ratio |
|---|---|---|
| | of each element | of each element |
| | when charged | contained in particles |
| | (Li:P:Mn) | (Li:P:Mn) |
| Test Example 1 | 2:1:1 | 0.95:1:1.03 |
| Test Example 2 | 2:1:1 | 0.95:1:1.03 |
| Test Example 3 | 2:1:1 | 0.93:1:1.01 |
| Test Example 4 | 2:1:1 | 0.89:1:0.97 |
| Test Example 5 | 2:1:1 | 0.91:1:0.99 |
| Test Example 6 | 2:1:1 | 0.96:1:1.05 |
| Test Example 11 | 2:1:1 | 0.90:1:0.98 |

### <Charge and Discharge Test>

A positive electrode material was prepared using a positive electrode material obtained in each test example. Specifically, the positive electrode material and acetylene black (AB) were weighed in a mass ratio of 80:8, and mixed with pulverizing in a mortar. Then, an N-methylpyrrolidone (NMP) solution of polyvinylidene fluoride (PVdF) (type No.: #1120) was dropped thereto and the mixture was kneaded. Thereto was further added NMP to dilute the solution, and the positive electrode material, AB and PVdF were contained in a mass ratio of 80:8:12, to prepare a paste for a positive electrode, which has a solid content concentration of 30% by mass. The paste for a positive electrode was coated on an Al mesh plate, and then dried at 80° C. for 30 minutes, thereafter performing pressure pressing and drying with reduced pressure to thus form a positive electrode plate. A Li metal was used for the negative electrode and a glass cell was used to produce a nonaqueous electrolyte secondary battery.

Using the nonaqueous electrolyte secondary battery, the charge and discharge test was performed in the following conditions. Charge at a constant current and a constant voltage was performed in the charging conditions of a charging current at 0.1 ItmA, a charge setting voltage at 4.5 V, and a charging time for 15 hours, and discharge at a constant current was performed in the discharge conditions of a discharging current at 0.1 ItmA and a discharge termination voltage at 2.0 V.

Materials used in production of a positive electrode material of each test example, amounts in use, and a discharge capacity in the charge and discharge test are shown in Table 2.

TABLE 2

| | | | | | | Discharge |
|---|---|---|---|---|---|---|
| | In hydrothermal synthesis | | | | | capacity |
| | | | | Carbon | In | In |
| | First | | Amount | atom | calcination | discharging |
| | organic | Reducing | added | conversion | Organic | at 0.1 ItmA |
| | compound | property | (mol/Mn) | (mol/Mn) | compound | (mAh/g) |
| Test | Ascorbic | Presence | 0.025 | 0.15 | PVA | 87.1 |
| Example 1 | acid | | | | | |
| Test | Ascorbic | Presence | 0.050 | 0.30 | PVA | 46.9 |
| Example 2 | acid | | | | | |
| Test | Ascorbic | Presence | 0.075 | 0.45 | PVA | 61.3 |
| Example 3 | acid | | | | | |
| Test | Ascorbic | Presence | 0.100 | 0.60 | PVA | 58.7 |
| Example 4 | acid | | | | | |
| Test | Ascorbic | Presence | 0.150 | 0.90 | PVA | 33.3 |
| Example 5 | acid | | | | | |
| Test | Ascorbic | Presence | 0.200 | 1.20 | PVA | 15.5 |
| Example 6 | acid | | | | | |
| Test | Sucrose | None | 0.100 | 1.20 | PVA | 31.4 |
| Example 7 | | | | | | |
| Test | Sucrose | None | 0.050 | 0.60 | PVA | 42.4 |
| Example 8 | | | | | | |
| Test | Tartaric | None | 0.100 | 0.40 | PVA | 62.6 |
| Example 9 | acid | | | | | |
| Test | Ascorbic | Presence | 0.025 | 0.15 | Triton | 76.9 |
| Example 10 | acid | | | | X-100 | |
| Test | — | — | — | — | PVA | 34.9 |
| Example 11 | | | | | | |
| Test | Ascorbic | Presence | 0.100 | 0.60 | — | 8.2 |
| Example 12 | acid | | | | | |
| Test | Ascorbic | Presence | 0.100 | 0.60 | PVA after | 14.0 |
| Example 13 | acid | | | | calcination | |
| Test | Citric | Presence | 0.100 | 0.60 | PVA | 10.4 |
| Example 14 | acid | | | | | |
| Test | Maleic | None | 0.100 | 0.40 | PVA | 16.4 |
| Example 15 | acid | | | | | |
| Test | — | — | — | — | Methanol | 2.0 |
| Example 16 | | | | | | |

Curves at the time of initial discharge of the charge and discharge test in nonaqueous electrolyte secondary batteries having the positive electrode materials of Test Example 4, Test Examples 11 to 13 are shown in FIG. 1.

As recognized from FIG. 1, a discharge capacity of nonaqueous electrolyte secondary battery with the positive electrode material in Test Example 4 is larger than those of the positive electrode materials in Test Examples 11 to 13.

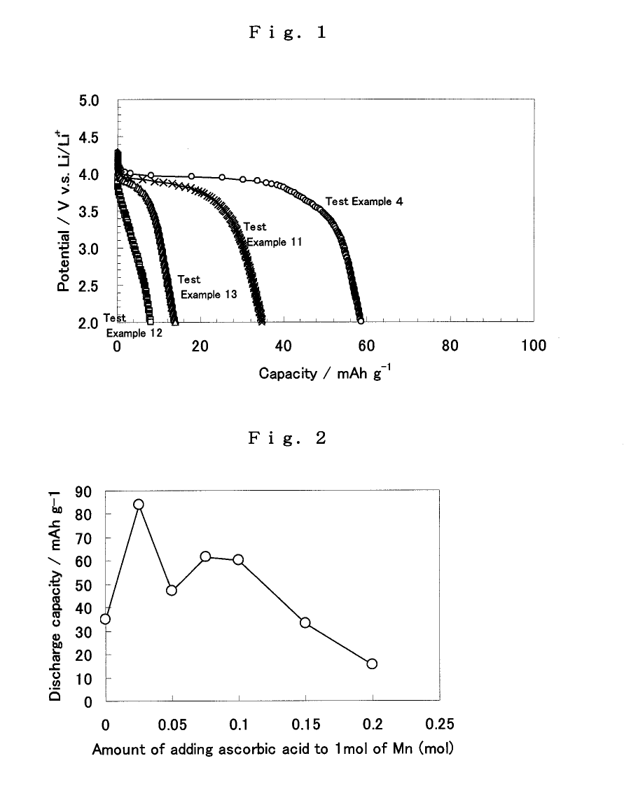

Results of discharge capacities at the initial discharge of the charge and discharge test in nonaqueous electrolyte secondary batteries having the positive electrode materials of Test Examples 1 to 6 and 11 are shown in FIG. 2.

As recognized from FIG. 2, when a hydrothermal synthesis step was performed using 0.025 to 0.1 mol of ascorbic acid with respect to 1 mol of manganese, that is, when a hydrothermal synthesis step was performed using ascorbic acid in an amount to contain 0.15 to 0.60 mol of a carbon amount converted into carbon atoms, a discharge capacity becomes particularly large.

Curves at the time of initial discharge of the charge and discharge test in nonaqueous electrolyte secondary batteries having the positive electrode materials of Test Examples 4, 8, 9, 11, 14 and 15 are shown in FIG. 3.

As recognized from FIG. 3, when ascorbic acid, sucrose or tartaric acid was used in a hydrothermal synthesis step, a discharge capacity becomes large as compared to the case of using citric acid or maleic acid. Such results lead to a consideration that presence or absence of a reducing property of substances used in the hydrothermal synthesis steps is irrelevant to a size of a discharge capacity of a battery.

As an additional remark, Example 2 in the Patent Document 1 describes that particles containing LiFePO₄ were synthesized in a hydrothermal method in the presence of ascorbic acid. Example 1.1 in JP-A No. 2006-66081 describes that a raw material obtained by mixing ascorbic acid that is a reducing agent was calcinated to synthesize particles containing LiFePO₄. When the particles containing LiFePO₄ are synthesized as described above, since an oxidation reaction speed of Fe is extremely high, it is essential that a reducing agent is coexisted in order to suppress oxidation of Fe. On the other hand, for synthesis of particles containing LiMnPO₄, an oxidation speed of Mn in general conditions is significantly low as compared to that of Fe, and thus, a reducing agent is not necessarily coexisted. In the above described test examples using LiMnPO₄, presence or absence of a reducing property of the first organic compound with a molecular weight of 350 or less, which has two or more hydroxy groups in a molecule, can be considered to be irrelevant to whether a discharge capacity of a nonaqueous electrolyte secondary battery is improved or not, as recognized also from Table 2.

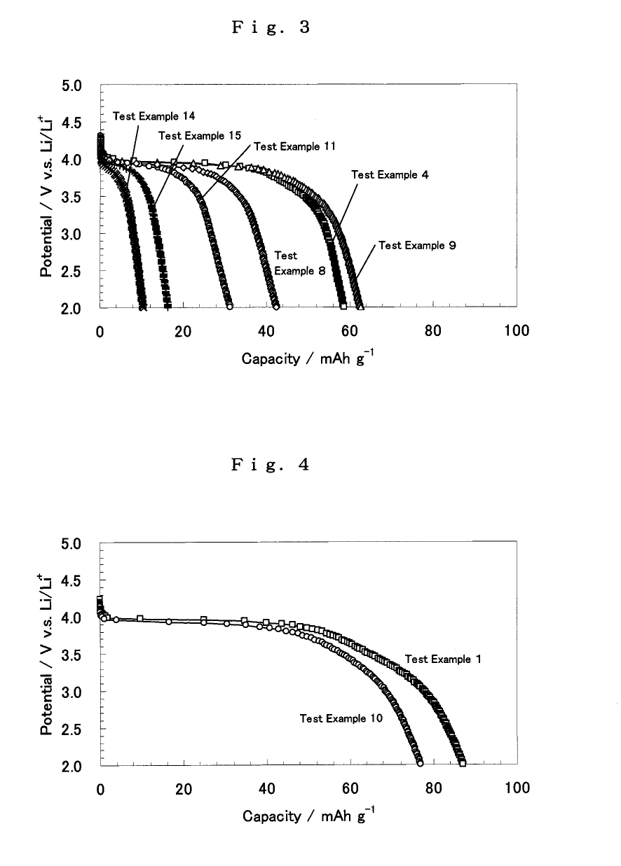

Curves at the time of initial discharge of the charge and discharge test in nonaqueous electrolyte secondary batteries having the positive electrode materials of Test Examples 1 and 10 are shown in FIG. 4.

As recognized from FIG. 4, also when a calcination step was performed using a polyoxyethylene-[4-(1,1,3,3-tetramethylbutyl)phenyl]ether other than a polyvinyl alcohol, a discharge capacity becomes comparatively large.

In a nonaqueous electrolyte secondary battery using the positive electrode material in Test Example 16 using methanol in the calcination step, a discharge capacity in the charge and discharge test was significantly low.

The Patent Document 1 shows that, by acting methanol on particles containing LiFePO₄, high rate discharge characteristics are excellent in the nonaqueous electrolyte secondary battery as compared to the case of acting PVA. In the above described test example intended for particles containing LiMnPO₄, however, when methanol is acted as in Test Example 16, a discharge capacity was significantly small as compared to the case of acting PVA. Although a factor of such a result that a discharge capacity becomes small when methanol is acted in the above test example intended for particles containing LiMnPO₄, that is, a result opposite to the case intended for particles containing LiFePO₄, has not been necessarily revealed, the factor is presumed to be associated with the fact that Mn does not have a catalyst action on carbon while Fe and Ni have catalyst actions on carbon.

### <Transmission Electron Microscope Observation>

In order to examine a shape of an active substance contained in a positive electrode material obtained in each test example and a distribution state of carbon present in the surface thereof, a sample prepared by a dispersion method was observed using a transmission electron microscope (TEM, manufactured by Hitachi, Ltd., model type “H-7100FA”).

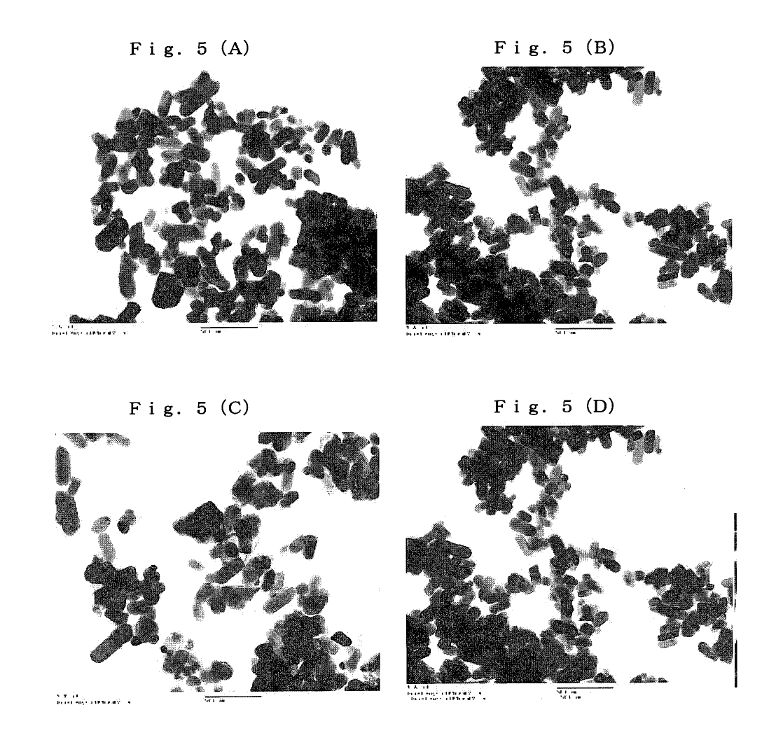

Specifically, the positive electrode materials produced in Test Examples 4 and 11 to 13 were observed with a transmission electron microscope. FIG. 5(A) shows the positive electrode material of Test Example 12, FIG. 5(B) shows the positive electrode material of Test Example 4, FIG. 5(C) shows the positive electrode material of Test Example 13, and FIG. 5(D) shows the positive electrode material of Test Example 11. Magnifications were the same in any of FIGS. 5(A) to 5(D).

When FIG. 5(D) and FIGS. 5(A) to 5(C) are compared, it can be recognized that, in FIG. 5(D) in Comparative Example 1 in which ascorbic acid was not used, a particle size is large as compared to the others. A reason thereof can be considered because particles were suppressed to become large due to presence of ascorbic acid.

When FIG. 5(B), and FIGS. 5(A) and 5(C) are compared, it can be recognized that in FIG. 5(B) in Test Example 4 in which particles formed by hydrothermal synthesis was calcinated in the presence of PVA, a particle size is small as compared to the others. A reason thereof can be considered because PVA aggregated adjacent to the surface of the particle due to a reciprocal action between a hydroxy group of ascorbic acid attached to a particle formed by hydrothermal synthesis and a hydroxy group of PVA and calcination was performed in such a state to thereby suppress coagulation of primary particles also due to a high temperature during the calcination by PVA.

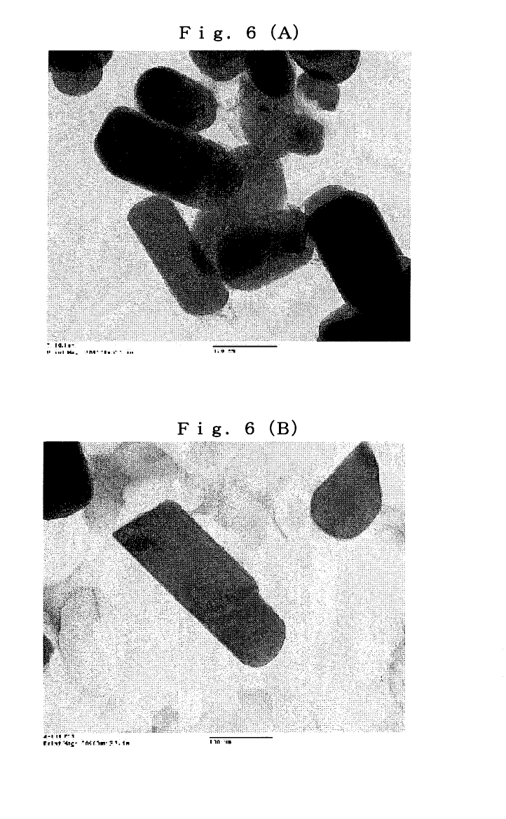

The positive electrode materials produced in Test Examples 4 and 11 were observed with a transmission electron microscope, increasing a magnification. Their observed images are shown in FIG. 6(A) and FIG. 6(B), respectively. In FIGS. 6(A) and 6(B), magnifications are the same, FIG. 6(A) is an image of the same sample as observed in FIG. 5(B), and FIG. 6(B) is an image of the same sample as observed in FIG. 5(D).

A projecting material of carbon was observed between particles in FIG. 6(A) in Test Example 4; on the other hand, carbon was observed to be independently present away from particles in FIG. 6(B) in Test Example 11. These observations can lead such a consideration that conductive carbon is present in the periphery of particles so as to connect between particles in the positive electrode material of the present embodiment, and networks capable of conducting electrons are considered to exists in a comparatively large amount.

### <Electron Beam Energy Loss Spectroscopy (EELS) Observation Using Scanning Transmission Electron Microscope (STEM)>

In order to clarify a distribution state of carbon present in the periphery of a particulate active substance, a distribution state of carbon was examined by the electron beam energy loss spectroscopy (EELS) measurement based on an image of a high-angle annular dark-field scanning transmission electron microscopy (HAADF-STEM) observed using an electric field emission-type electron microscope (HRTEM, manufactured by JEOL Co., model type “JEM2100F”).

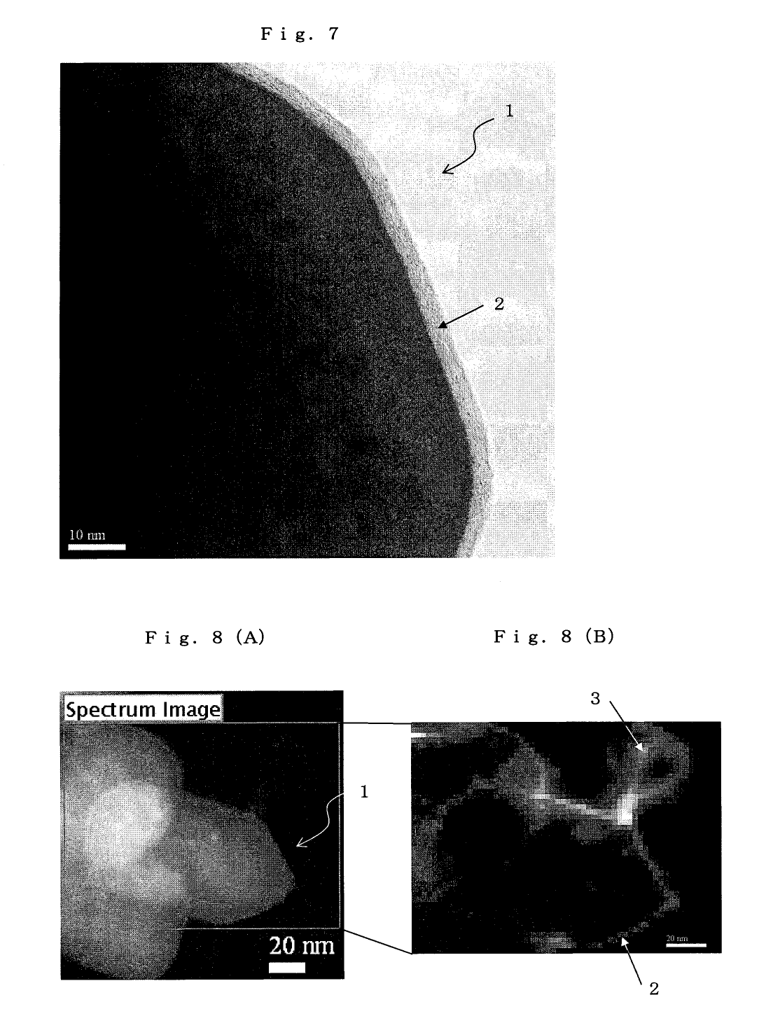

An observed image of the positive electrode material produced in Test Example 4 observed with a scanning transmission electron microscope (STEM image) is shown in FIG. 7.

As recognized from FIG. 7, a membranous material having a thickness of about 3 to 4 nm that is considered to contain carbon is present in a particle surface.

After the STEM observation on a particle of the positive electrode material in Test Example 4, a distribution state of carbon was examined in the same portion as the image by the electron beam energy loss spectroscopy (EELS method). Results thereof are respectively shown in FIG. 8(A) and FIG. 8(B).

As recognized also from the fact that a white portion in FIG. 8(B) shows presence of carbon by the EELS method, a membranous material containing carbon is present in the surface of the particle and a projecting material containing carbon, which projects outward from the membranous material, is present in the periphery of the particle. Carbon present in the membranous material is considered to be derived from ascorbic acid used in the hydrothermal synthesis step, and carbon present in the projecting material is considered to be derived from PVA used in the carbon calcination step.

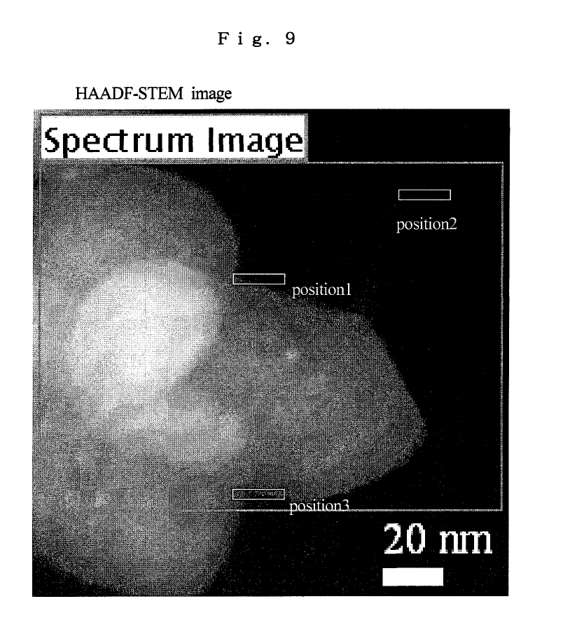

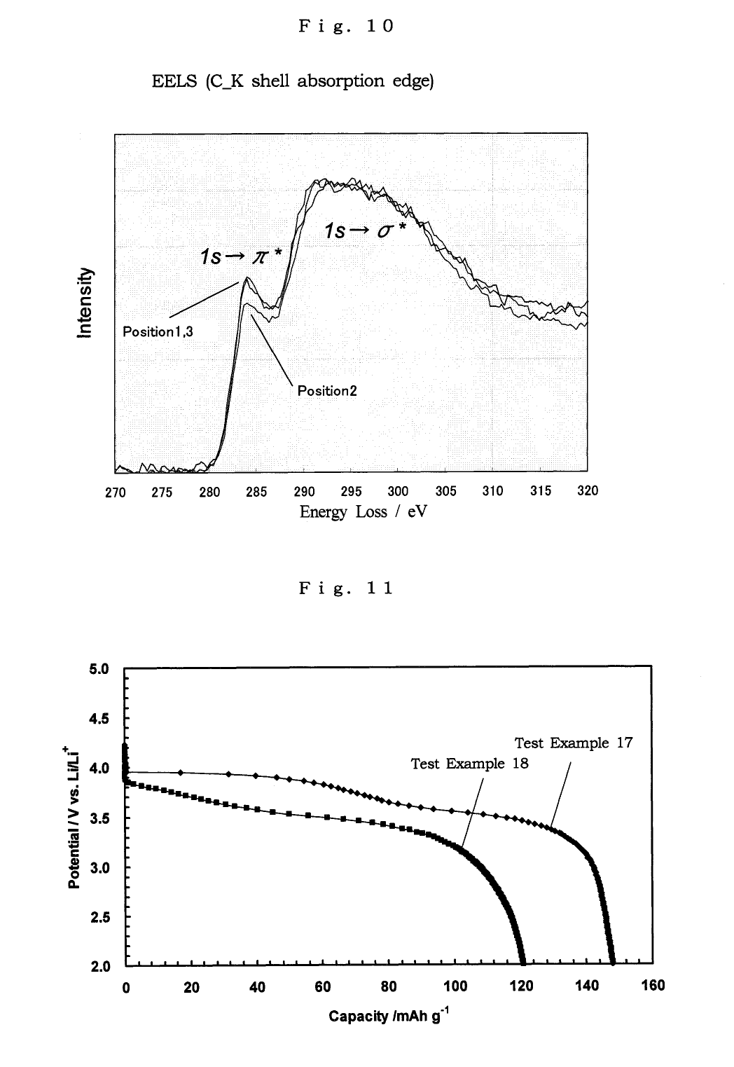

By comparing peaks corresponding to sp² orbital reflecting degrees of crystallinities using the EELS method, crystallinities of carbon present in the membranous material and carbon present in the projecting material were compared. That is, as shown in FIG. 9, membranous material portions of position 1 and position 3 and a projecting material portion of position 2 were measured. Measurement results are shown in FIG. 10. It was found in FIG. 10 that peaks corresponding to sp² orbital were observed at around an energy loss value of 283 eV, and the peak intensity corresponding to position 2 was low as compared to peaks strengths corresponding to position 1 and position 3. This fact revealed that crystallinity of carbon present in the projecting material is lower than that of carbon present in the membranous material. It is considered that the positive electrode material used in the charge and discharge test contains acetylene black and crystallinity of acetylene black is higher than that of carbon present in the membranous material.

In the positive electrode material of the present embodiment, particles containing lithium manganese phosphate is formed by a hydrothermal method in the presence of the first organic compound with a molecular weight of 350 or less, which has two or more hydroxy groups in a molecule, to perform a hydrothermal synthesis step, thereby attaching the first organic compound to the particles, and further, the particles were calcinated in the presence of the second organic compound with a molecular weight of 500 or more, which has a hydroxy group in a molecule, to perform a calcination step, thereby carbonizing the first organic compound and the second organic compound loaded on the first organic compound. As a result, a membranous material containing carbon and present in a surface of a particle and a projecting material containing carbon and projecting outward from the membranous material are provided in a particulate active substance containing lithium manganese phosphate in the positive electrode material of the present embodiment, as recognizable from FIGS. 6 to 8. It is considered that electron conductivity of the positive electrode material of the present embodiment was enhanced by carbons contained in the membranous material and the projecting material, and as a result, a discharge capacity of a battery using the positive electrode material became large.

### Test Example 17

A positive electrode material was produced according to the method shown below.

Lithium hydroxide [LiOH.H₂O] and ammonium hydrogen phosphate [(NH₄)₂HPO₄] were respectively dissolved in ion exchange water, and the both solutions were then mixed with stirring.

Manganese sulfate [MnSO₄.5H₂O] and iron sulfate [FeSO₄.7H₂O] were then dissolved in an aqueous solution dissolved with ascorbic acid. Ascorbic acid in an amount of 0.1 mol was used with respect to 1 mol of manganese in manganese sulfate. That is, ascorbic acid was used in such an amount that carbon atoms in a molecule of the ascorbic acid was 0.6 mol with respect to 1 mol of manganese.

Subsequently, this aqueous solution was added to the mixed solution of lithium hydroxide [LiOH.H₂O] and diammonium hydrogen phosphate [(NH₄)₂HPO₄] to thereby obtain a precursor solution. A ratio of Li:P:Mn:Fe in the precursor solution was adjusted to 2:1:0.8:0.2 by a molar ratio. This precursor solution was transferred to a tetrafluoroethylene container, the container was then set in a reaction vessel and the inside of the vessel was sufficiently replaced with a N₂ gas and sealed, and synthesis was carried out by a hydrothermal method at 170° C. for 15 hours to perform the hydrothermal synthesis step.

The generated substance was sufficiently washed with deionic water and acetone, and then subjected to vacuum drying at 100° C. for 1 hour, to thereby obtain particles containing LiMn_{0.8}Fe_{0.2}PO₄.

Thereto were added a polyvinyl alcohol (PVA) (made by Wako Pure Chemicals K.K., average polymerization degree of 1500) in an amount of 1.2 g per 1 g of the particles and water heated to 60° C. to mix and knead in a mortar, and the resultant mixture was then subjected to a heat treatment at 700° C. for 1 hour in a N₂ gas atmosphere to thereby perform the calcination step. An amount of the polyvinyl alcohol used was set to such an amount that a carbon amount calculated from a mass increase was 5% by mass based on the particles containing LiMn_{0.8}Fe_{0.2}PO₄.

### Test Example 18

A positive electrode material was obtained in the same manner as in Test Example 17 except for performing a thermal treatment at 700° C. for 1 hour without using a polyvinyl alcohol in place of the calcination step.

### <Charge and Discharge Test>

A positive electrode was prepared using a positive electrode material obtained in each of Test Examples 17 and 18. Specifically, the positive electrode material and acetylene black (AB) were weighed in a mass ratio of 80:8, and mixed with pulverizing in a mortar. Then, an N-methylpyrrolidone (NMP) solution of polyvinylidene fluoride (PVdF) (type No.: #1120) was dropped thereto and the mixture was kneaded. Thereto was further added NMP to dilute the solution, and the positive electrode material, AB and PVdF were contained in a mass ratio of 80:8:12, to prepare a paste for a positive electrode, which has a solid content concentration of 30% by mass. The paste for a positive electrode was coated on an Al mesh plate, and then dried at 80° C. for 30 minutes, thereafter performing pressure pressing and drying with reduced pressure to thus form a positive electrode plate. A Li metal was used for the negative electrode and a glass cell was used to produce a nonaqueous electrolyte secondary battery.

Using the nonaqueous electrolyte secondary battery, the charge and discharge test was performed in the following conditions. Charge at a constant current and a constant voltage was performed in the charging conditions of a charging current at 0.1 ItmA, a charge setting voltage at 4.5 V, and a charging time for 15 hours, and discharge at a constant current was performed in the discharge conditions of a discharging current at 0.1 ItmA and a discharge termination voltage at 2.0 V.

Materials used in production of the positive electrode materials of Test Examples 17 and 18, amounts in use, and discharge capacities in the charge and discharge test are shown in Table 3.

TABLE 3

| | | | | | | Discharge |
|---|---|---|---|---|---|---|
| | In hydrothermal synthesis | | | | | capacity |
| | | | | Carbon | In | In |
| | First | | Amount | atom | calcination | discharging |
| | organic | Reducing | added | conversion | Organic | at 0.1 ItmA |
| | compound | property | (mol/Mn) | (mol/Mn) | compound | (mAh/g) |
| Test | Ascorbic | Presence | 0.100 | 0.60 | PVA | 148 |
| Example 17 | acid | | | | | |
| Test | Ascorbic | Presence | 0.100 | 0.60 | — | 121 |
| Example 18 | acid | | | | | |

Curves at the time of initial discharge of the charge and discharge test in nonaqueous electrolyte secondary batteries having the positive electrode materials of Test Examples 17 and 18 are shown in FIG. 11.

As recognizable from FIG. 9, a discharge capacity of nonaqueous electrolyte secondary battery with the positive electrode material in Test Example 17 is larger than that of the positive electrode material in Test Example 18.

### DESCRIPTION OF THE REFERENCE NUMERALS

1: particulate active substance
2: membranous material
3: projecting material

What is claimed is:

1. A positive electrode material comprising a particulate active substance containing lithium manganese phosphate, wherein the particulate active substance is provided with a membranous material containing carbon and attached to the surface of the particulate active substance, and a projecting material containing carbon and projecting outward from the surface of the particulate active substance or the membranous material.

2. The positive electrode material according to claim 1, wherein the membranous material and the projecting material have different peak intensities corresponding to sp² orbital observed in the EELS method.

3. The positive electrode material according to claim 1, wherein the membranous material has a larger peak intensity corresponding to the sp² orbital observed in the EELS method than a peak intensity of the projecting material.

4. The positive electrode material according to claim 1, wherein the membranous material covers the entire surface of the particulate active substance.

5. The positive electrode material according to claim 2, wherein the membranous material covers the entire surface of the particulate active substance.

6. The positive electrode material according to claim 3, wherein the membranous material covers the entire surface of the particulate active substance.

7. A positive electrode material comprising a particulate active substance containing lithium manganese phosphate, which is obtained by a hydrothermal synthesis step of forming a particle containing lithium manganese phosphate by a hydrothermal method in the presence of a first organic compound with a molecular weight of 350 or less, which has two or more hydroxy groups in a molecule, and a calcination step of calcinating the particle in the presence of a second organic compound with a molecular weight of 500 or more, which has a hydroxy group in a molecule.

8. The positive electrode material according to claim 7, wherein the first organic compound is present so as to contain carbon atoms in a molecule in an amount of 0.15 to 0.60 mol with respect to 1 mol of manganese in the hydrothermal synthesis step.

9. A method for producing a positive electrode material comprising a particulate active substance containing lithium manganese phosphate, the method comprising a hydrothermal synthesis step of forming a particle containing lithium manganese phosphate by a hydrothermal method in the presence of a first organic compound with a molecular weight of 350 or less, which has two or more hydroxy groups in a molecule; and a calcination step of calcinating the particle in the presence of a second organic compound with a molecular weight of 500 or more, which has a hydroxy group in a molecule.

10. The method for producing a positive electrode material according to claim 9, wherein the first organic compound is present so as to contain carbon atoms in a molecule in an amount of 0.15 to 0.60 mol with respect to 1 mol of manganese in the hydrothermal synthesis step.

11. A positive electrode material, which is produced by the production method according to claim 9.

12. A positive electrode material, which is produced by the production method according to claim 10.

13. A nonaqueous electrolyte secondary battery, comprising the positive electrode material according to claim 1.

14. A nonaqueous electrolyte secondary battery, comprising the positive electrode material according to claim 2.

15. A nonaqueous electrolyte secondary battery, comprising the positive electrode material according to claim 3.

16. A nonaqueous electrolyte secondary battery, comprising the positive electrode material according to claim 4.

17. A nonaqueous electrolyte secondary battery, comprising the positive electrode material according to claim 7.

18. A nonaqueous electrolyte secondary battery, comprising the positive electrode material according to claim 8.

19. A nonaqueous electrolyte secondary battery, comprising the positive electrode material according to claim 11.

20. A nonaqueous electrolyte secondary battery, comprising the positive electrode material according to claim 12.
